(19) United States
(12) Patent Application Publication
(10) Pub. No.: US 2022/0213714 A1
(43) Pub. Date: Jul. 7, 2022

(54) Hands-Free Sanitary Door Assist

(71) Applicant: Intellectual Property Holdings, LLC - Client 7020, Barrington, IL (US)

(72) Inventor: Richard Kirk Cannon, Barrington Hills, IL (US)

(73) Assignee: Intellectual Property Holdings, LLC - Client 7020, Barrington, IL (US)

(21) Appl. No.: 17/700,882

(22) Filed: Mar. 22, 2022

Related U.S. Application Data
(63) Continuation-in-part of application No. 17/521,830, filed on Nov. 8, 2021.
(60) Provisional application No. 63/111,001, filed on Nov. 7, 2020.

(51) Int. Cl. E05B 1/00

(52) U.S. Cl. CPC E05B 1/0053; E05B 1/0015

(57) ABSTRACT

A device for handling a door is provided, the door having a door handle which comprises a stem and a hand grip. The device includes a base unit and an extension unit. The base unit has a channel opening at a bottom section of the base unit, the channel being closed by a top section of the base unit. The channel is configured to receive at least one portion of the stem of the door handle so as to slip the base unit onto the door handle to connect the base unit to the door handle. The extension unit extends outwardly from the base unit and include a panel substantially parallel to the door, such that a force applied on the panel is transferred to the base unit, via the base unit to the door handle, and via the door handle to the door.

### CROSS-REFERENCES TO RELATED APPLICATIONS

The present application is a continuation-in-part of U.S. patent application Ser. No. 17/521,830 filed on Nov. 8, 2021, which claims priority from U.S. Provisional Application Ser. No. 63/111,001 filed on Nov. 7, 2020. Both U.S. patent application Ser. No. 17/521,830 and U.S. Provisional Application Ser. No. 63/111,001 are hereby incorporated herein by reference in their entirety.

### TECHNICAL FIELD

The present application, in some embodiments thereof, relates to door handles, door knobs, or any devices for opening doors.

### BACKGROUND

At restaurant outdoor patios, waiters and bus staff struggle to open the door to the inside or close the door to the outside, when both hands are occupied carrying items (e.g., plates, trays, etc.). Due to health challenges associated with the Covid-19 virus pandemic and other infectious agents which may reside on solid surfaces, such as a door knob or door handle, opening and closing the door by grasping the knob or handle can further spread the infectious agents. Pressure-mats and motion detector actuated automatic door openers provide hands-free solutions but are expensive to implement. Foot actuated or operated devices can cause the operator to lose stability and balance.

### BRIEF SUMMARY OF THE INVENTION

An aim of the system of the present invention is to provide a more sanitary and cost-effective solution to open doors (e.g. in restaurant restrooms, doors to kitchen, doors to inside from outdoor patios, etc.) without constantly grasping the door knob or handle with human hands.

Therefore, an aspect of some embodiments of the present invention relates to a device for handling a door, the door having a door handle which comprises a stem and a hand grip. The device includes a base unit and an extension unit. The base unit has a channel opening at a bottom section of the base unit, the channel being closed by a top section of the base unit. The channel is configured to receive at least one portion of the stem of the door handle so as to slip the base unit onto the door handle to connect the base unit to the door handle. The extension unit extends outwardly from the base unit and include a panel substantially parallel to the door, such that a force applied on the panel is transferred to the base unit, via the base unit to the door handle, and via the door handle to the door.

In a variant, the base unit is further configured to surround the hand grip, and the channel is shaped to further receive the hand grip.

In another variant, the base unit is configured to hold the stem between the door and the hand grip.

In yet another variant, the channel is configured for a snug connection with the at least one portion of the stem.

In some embodiments of the present invention, the panel of the extension unit extends beyond a width of the door.

In a variant, the base unit has a rear surface facing the door when the base unit is connected to the door handle, a front surface facing away from the door when the base unit is connected to the door handle, and lateral surfaces extending on lateral sides of the base unit between the rear surface and the front surface. The device comprises a connection unit connecting the panel to one of the lateral surfaces of the base unit.

Optionally, the connection unit tapers from the front surface to the rear surface.

In some embodiments of the present invention, the base unit has a rear surface facing the door and front surface facing away from the door, when the base unit is connected to the door handle. The extension unit comprises a connection unit extending forward from the front surface, the connection unit having a front section joined to the panel, such that a gap is formed between the panel and the front surface of the base unit.

In a variant, the panel has a rear surface facing the base unit and front surface facing away from the base unit. The rear surface of the panel is joined to the connection unit at an angle larger than 90 degrees and smaller than or equal to 180 degrees.

In another variant, the base unit has a first lateral side and a second later side opposite each other and connecting the front surface to the rear surface. The connection unit extends forward from a portion of the front surface at or near the first lateral side. The panel extends laterally, ahead of the front surface, from the connection unit in a direction that extends from the first lateral side to the second lateral side.

In yet another variant, the base unit has a first lateral side and a second later side opposite each other and connecting the front surface to the rear surface. The connection unit extends forward from a portion of the front surface at or near the second first lateral side. The panel extends laterally, ahead of the front surface, from the connection unit in a direction that extends from the second lateral side to the first lateral side.

In some embodiments of the present invention, the base unit has a rear surface facing the door and front surface facing away from the door, when the base unit is connected to the door handle. The extension unit comprises a connection unit extending forward from the front surface, the connection unit having a front section joined to the panel. The base unit has a first lateral side facing a hinge end of the door and a second later side opposite the first lateral side, the first lateral side and the second lateral side connecting the front surface to the rear surface. The connection unit extends forward from a portion of the front surface at or near the second lateral side. The panel extends toward a hinge end of the door.

### BRIEF DESCRIPTION OF DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom”, or “side” views, such references are merely descriptive and do not imply or require that the invention be implemented or used in a particular spatial orientation unless explicitly stated otherwise.

FIG. 1 is a top cross-sectional view of a device for handling a door, in which a panel extends laterally from a base unit, according to some embodiments of the present invention;

FIG. 2 is a top cross-sectional view of a device for handling a door, in which a panel extends laterally from a base unit and a connection unit with a rounded surface, according to some embodiments of the present invention;

FIG. 3 is a top cross-sectional view of a device for handling a door, in which a base unit surrounds the door handle and a panel extends laterally from a base unit, according to some embodiments of the present invention;

FIG. 4 is a front view of the device of FIG. 3, according to some embodiments of the present invention;

FIG. 5 is a rear view of the device of FIG. 3, according to some embodiments of the present invention;

FIG. 6 is a bottom view of the device of FIG. 3, according to some embodiments of the present invention;

FIG. 7 is a perspective view of the device of FIG. 3 before connection to the door handle, according to some embodiments of the present invention;

FIG. 8 is a perspective view of the device of FIG. 3 after connection to the door handle, according to some embodiments of the present invention;

FIGS. 9 and 10 are a perspective view of the device of FIG. 3, configured to connect to a door handle by receiving the hand grip and only part of the stem in the channel, according to some embodiments of the present invention;

FIGS. 11 and 12 are a perspective view of the device of FIG. 3, in which the channel is shorter than the door handle, according to some embodiments of the present invention;

FIGS. 13 and 14 are a perspective view of the device of FIG. 3, in which the channel matches the same of door handle in which the stem is a single shaft and the hand grip is bulb-shaped, according to some embodiments of the present invention;

FIG. 15 is a top cross-sectional view of a device for handling a door, in which a panel is located ahead of the base unit and in which the panel extends toward a hinge end of the door, according to some embodiments of the present invention;

FIG. 16 is a top cross-sectional view of a device for handling a door, in which a panel is located ahead of the base unit and in which the panel extends toward a hinge end of the door, where a connection unit has a rounded surface, according to some embodiments of the present invention;

FIG. 17 is a top cross-sectional view of a device for handling a door, in which, in which a base unit surrounds the door handle and a panel is located ahead of the base unit and extends toward a hinge end of the door, according to some embodiments of the present invention;

FIG. 18 is a front view of the device of FIG. 17, according to some embodiments of the present invention;

FIG. 19 is a rear view of the device of FIG. 17, according to some embodiments of the present invention;

FIG. 20 is a bottom view of the device of FIG. 17, according to some embodiments of the present invention;

FIG. 21 is a perspective view of the device of FIG. 17 before connection to the door handle, according to some embodiments of the present invention;

FIG. 22 is a perspective view of the device of FIG. 17 after connection to the door handle, according to some embodiments of the present invention;

FIG. 23 is a top cross-sectional view of a device for handling a door, in which a panel is located ahead of the base unit and in which the panel extends away from a hinge end of the door, according to some embodiments of the present invention;

FIG. 24 is a top cross-sectional view of a device for handling a door, in which a panel is located ahead of the base unit and in which the panel extends away from a hinge end of the door, where a connection unit has a rounded surface, according to some embodiments of the present invention;

FIG. 25 is a top cross-sectional view of a device for handling a door, in which, in which a base unit surrounds the door handle and a panel is located ahead of the base unit and extends away from a hinge end of the door, according to some embodiments of the present invention;

FIG. 26 is a front view of the device of FIG. 25, according to some embodiments of the present invention;

FIG. 27 is a rear view of the device of FIG. 25, according to some embodiments of the present invention;

FIG. 28 is a bottom view of the device of FIG. 25, according to some embodiments of the present invention;

FIG. 29 is a perspective view of the device of FIG. 25 before connection to the door handle, according to some embodiments of the present invention;

FIG. 30 is a perspective view of the device of FIG. 25 after connection to the door handle, according to some embodiments of the present invention; and

FIG. 31 is a top cross-sectional view of a device for handling a door, in which a connection unit extend forward from a front surface of a base unit which is near a lateral surface facing the hinge end of the door, and a panel extends from the connection unit toward a hinge end of the door to form a gap between the door and the panel, according to some embodiments of the present invention; and

FIG. 32 is a perspective view of the device of FIG. 1 before connection to the door handle, according to some embodiments of the present invention; and

FIG. 33 is a perspective view of the device of FIG. 1 after connection to the door handle, according to some embodiments of the present invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

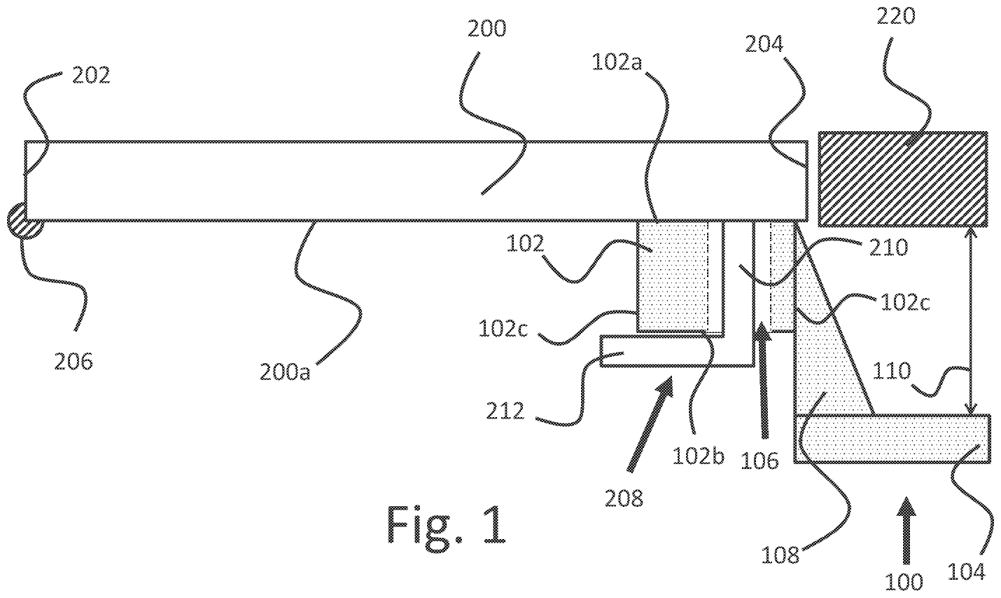

Referring now to the figures FIG. 1 is a top cross-sectional view of a device for handling a door, in which a panel extends laterally from a base unit, according to some embodiments of the present invention.

The device 100 is configured to be joined to a door 200 for handling (opening and closing) the door 200 in a hands-free manner, as will be explained below. The door 200 extends between a hinge end 202 of the door and handle end 204 of the door. The hinge end 202 is joined to a door frame via one or more hinges 206, such that rotation of the door 200 around the hinge(s) 206 is used to selectively open the door 200 and close the door 200. The handle end 204 is opposite the hinge end 202. A door handle 208 is located on the door near the handle end 204, to enable a user to hold the door and apply a force to the door and cause the door to rotate about the hinge(s) 206.

The door handle 208 includes a stem 210 and a hand grip 212. The stem is joined to the door 200 and extends forward from a front surface 200a of the door 200. The hand grip 212 is joined to the stem and is shaped to enable the user to grip the hand grip 212 and pull or push the door 200 to cause the door 200 to rotate around the hinge(s) 206.

The device 100 includes a base unit 102 and an extension unit or panel 104. The base unit has channel 106 opening at a bottom section of the base unit 102 and closed by a top section of the base unit 102 (as will be seen in later figures). The channel is shaped to receive at least one portion of the stem 210 of the door handle 212 so as to slip the base unit 102 onto the door handle 208 and connect the base unit 102 to the door handle 208. In the drawings, the channel 106 is shown to be substantially larger that the door handle, for clarity purposes alone. In some embodiments of the present invention, the channel 106 is shaped to provide a supple and stable fit over the door handle 208. Thereby, the base unit 102 and the door handle 208 make a sturdy snug fit connection, without requiring further reinforcements. The orientation of the base unit 102 relative to the door handle 208 remains fixed. The base unit 102 can be designed or configured to fit tightly against the front surface 200a of the door 200 so that leverage forces against the front surface 200a of door 200 helps stabilize the base unit 102. This prevents the base unit 102 from becoming loose or “wobbly” over time.

The extension unit 104 extends outwardly from the base unit 102 and includes a panel substantially parallel to the door. A force applied on the panel of the extension unit 104 is transferred to the base unit 102, via the base unit to the door handle 208, and via the door handle 208 to the door 200. In the embodiment of the FIG. 1, the extension unit 104 extends beyond the width of the door 200. In some embodiments of the present invention, the base unit 102 has a rear surface 102a facing the door 200 when the base unit 102 is connected to the door handle 208, a front surface facing 102b away from the door 208 when the base unit 102 is connected to the door handle 208, and lateral surfaces 102c extending on lateral sides of the base unit 102 between the rear surface 102a and the front surface 102b. In some embodiments of the present invention the extension unit (panel) 104 extends sideways from the base unit either directly from the base unit 102 or via a connection unit 108 which connects one of the lateral surfaces 102c of the base unit 102 to the panel 104 (as shown in the example of FIG. 1). In the example of FIG. 1, the panel 104 extends away from the hinge end 202 of the door and extends beyond the width of the door.

When the device 100 is joined to the door handle 208, a gap 110 is formed between a wall 220 (which lies beyond the handle end 204 of the door) and the panel 104. In this manner, a shoulder or elbow of a user can be physically inserted in the gap 110 to contact the panel 104 and apply a force against the panel 104. The force received by the panel 104 is transferred to the base unit 102, the door handle 208, and door 200, and therefore enables a user to open the door in a hands-free manner.

In the example of FIG. 1, the base unit 102 connects to the panel 104 via a connection unit 108. The connection unit 108 may taper from front to rear and may be wider near the panel 104 than near the door 200. In this manner the connection line between the connection unit 108 and the panel 104 is at an angle that is larger than 90 degrees. This forms a V-shaped reinforcement location between the connection unit 108 and the panel 104, and adds structural strength to the device 100. In this manner, bending at the connection location is decreased and a force applied to the panel 104 is more efficiently transferred to the base unit 102 and the door 104. Moreover, the added structural integrity increases the resistance of the panel 104 to breakage from the connection unit when a force is applied to the panel 104.

While the base unit 102, panel 104, and connection unit 108 are described as different units, these units may be integral with each other and formed as a single piece of material, such as molded plastic. In another variant, one or more may be discrete units joined to each other. The finish of the base unit 102 may smooth as to not scrape the front surface 200a of the door 200 or the door handle 208.

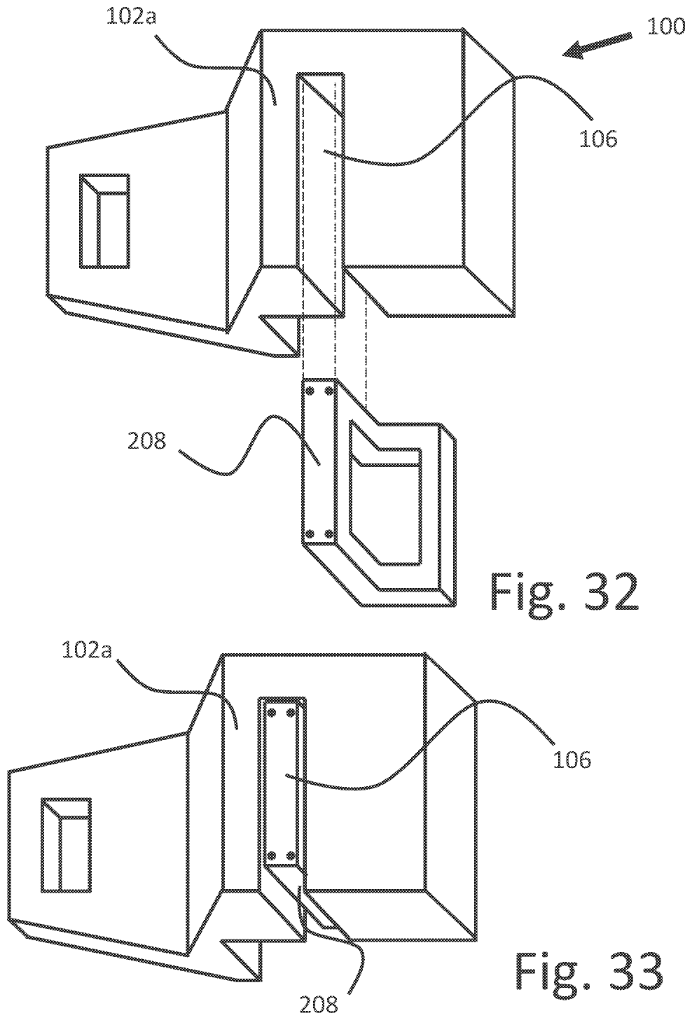

FIG. 32 is a perspective view of the device 100 of FIG. 1 before connection to the door handle 208, according to some embodiments of the present invention. FIG. 33 is a perspective view of the device 100 of FIG. 1 after connection to the door handle 208, according to some embodiments of the present invention.

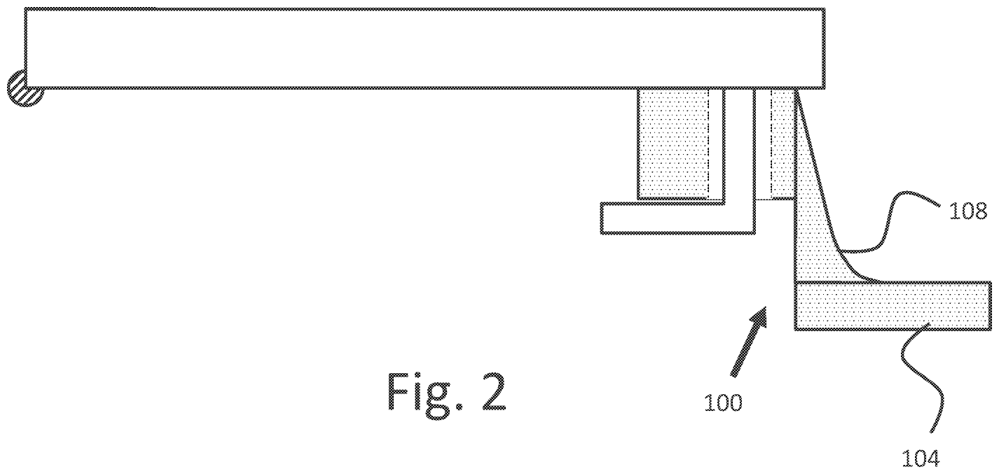

FIG. 2 is a top cross-sectional view of a device for handling a door, in which a panel extends laterally from a base unit and a connection unit with a rounded surface, according to some embodiments of the present invention.

The device 100 of FIG. 2 has all the features of device 100 of FIG. 1, described above. The difference lies in the fact that in FIG. 2, the connection unit 108 has a curved surface, such that the reinforcement location at which the connection unit 108 and the panel 104 meet is about 180 degrees.

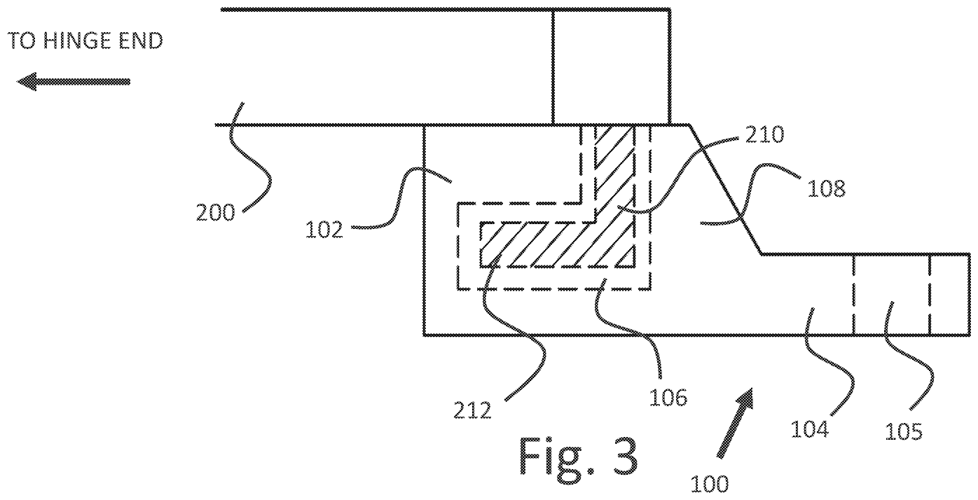

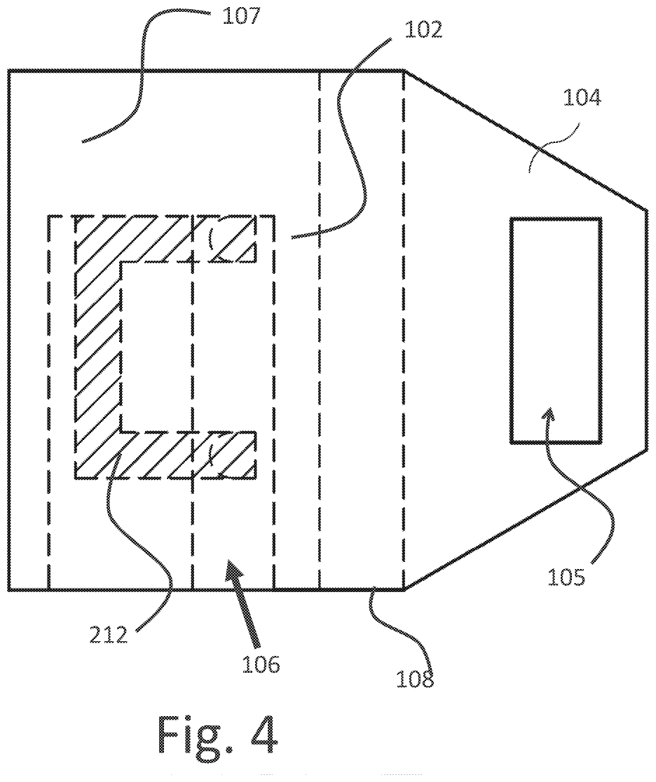

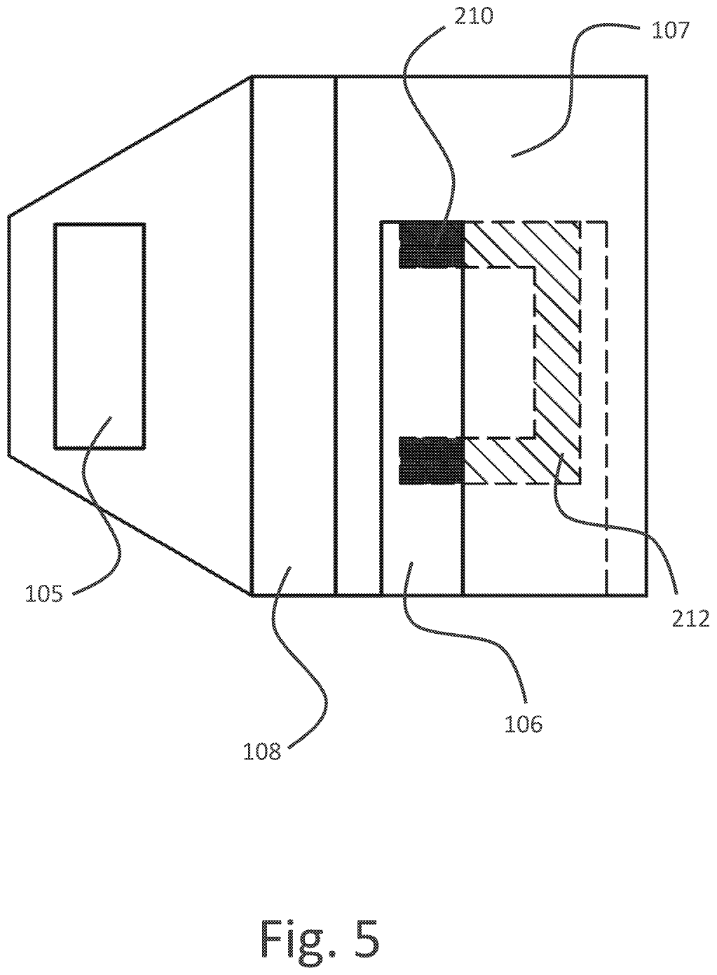

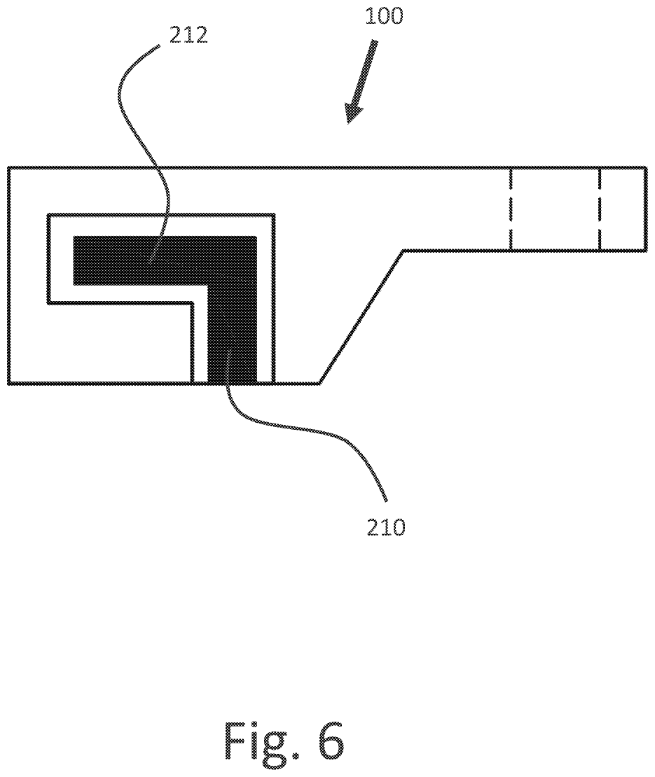

FIG. 3 is a top cross-sectional view of a device for handling a door, in which a base unit surrounds the door handle and a panel extends laterally from a base unit, according to some embodiments of the present invention. FIG. 4 is a front view of the device of FIG. 3, according to some embodiments of the present invention. FIG. 5 is a rear view of the device of FIG. 3, according to some embodiments of the present invention. FIG. 6 is a bottom view of the device of FIG. 3, according to some embodiments of the present invention.

The device 100 of FIGS. 3-6 is similar to the device 100 of FIG. 1 and of FIG. 2. In addition to all the features described with reference to FIGS. 1 and 2, the base unit 102 of the device 100 of FIGS. 3-6 also surrounds the hand grip 212. Therefore, the channel 106 is shaped to receive at least one portion of the stem 210 of the door handle and also to receive the hand grip 212 of the door handle. As mentioned above, in some embodiments of the present invention, the channel 106 is configured for a snug connection with the door handle (stem 210 and hand grip 212) to prevent wobbling and to efficiently transfer force from the panel 104 to the door 200.

In the examples of FIGS. 3 to 6, the connection between the connection unit 108 and the panel 104 is angular, as described with reference to FIG. 1. However, in some embodiments of the present invention, the connection between the connection unit 108 and the panel 104 is curved, as described above, with reference to FIG. 2.

FIGS. 4 and 5 show that the top section 107 of the base unit 102 is closed, to stop the device 100 from slipping down the door handle and falling on the floor. Due to this stopping function of the top section 107 of the base unit, the door handle supports the weight of the device 100 when the device 100 is joined to the door handle.

In some embodiments of the present invention, the panel 104 includes a perforation 105 configured to be used to grip the device 100 and function as a hand grip. The panel 104 may be of any shape. In the non-limiting examples of FIGS. 4 and 5, the panel 104 has a trapezoidal front cross-section, but it may be of any shape, such as square, round, rectangular, irregular with curved and straight sides, etc.

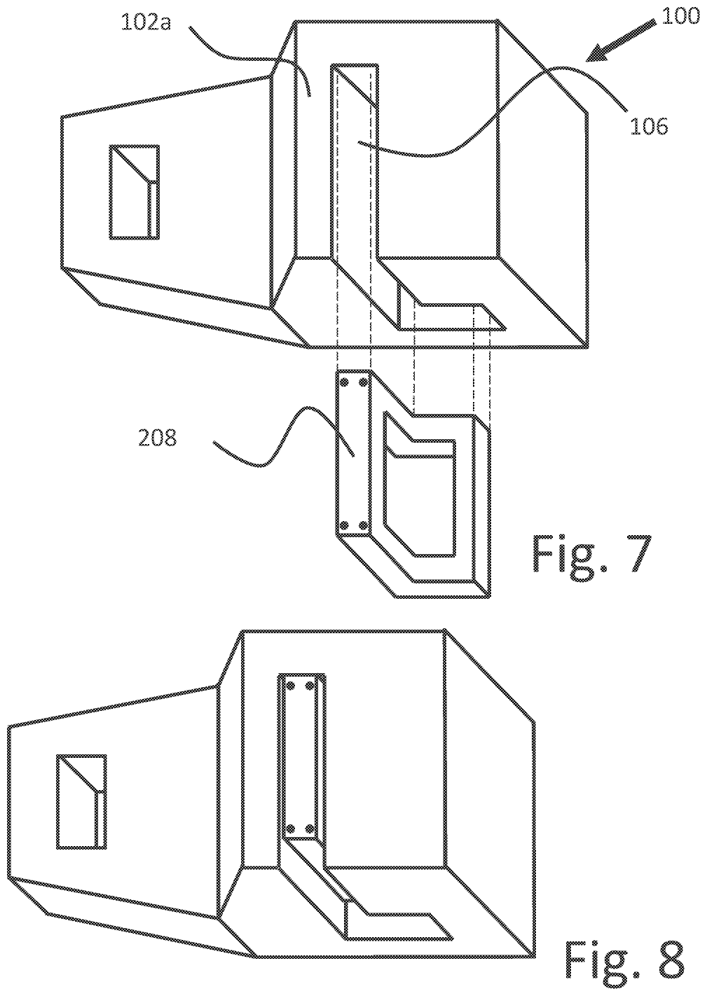

FIG. 7 is a perspective view of the device of FIG. 3 before connection to the door handle, according to some embodiments of the present invention. FIG. 8 is a perspective view of the device of FIG. 3 after connection to the door handle, according to some embodiments of the present invention.

FIGS. 7 and 8 are three-quarters views showing the rear surface 102a of the base unit. In the example of FIGS. 7 and 8, the channel 106 and the door handle 208 have L-shaped bottom cross-sections. The entirety of the door handle 208 is enclosed in the channel. The rear surface of the door handle 208 is flush with the rear surface 102a of the base unit.

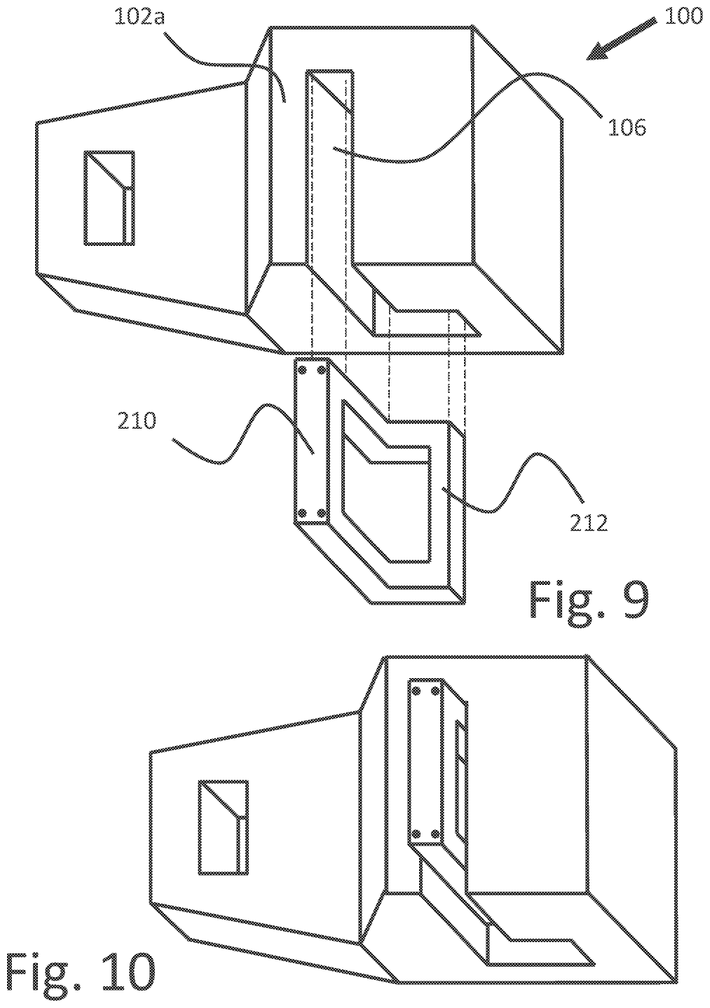

FIGS. 9 and 10 are a perspective view of the device of FIG. 3, configured to connect to a door handle by receiving the hand grip and only part of the stem in the channel, according to some embodiments of the present invention.

FIGS. 9 and 10 are three-quarters views showing the rear surface 102a of the base unit. In the example of FIGS. 9 and 10, the channel 106 and the door handle 208 have L-shaped bottom cross-sections. The hand grip 212 and a portion of the stem 210 are enclosed in the channel 106, while another portion of the stem 210 juts out from the rear surface 102a of the base unit.

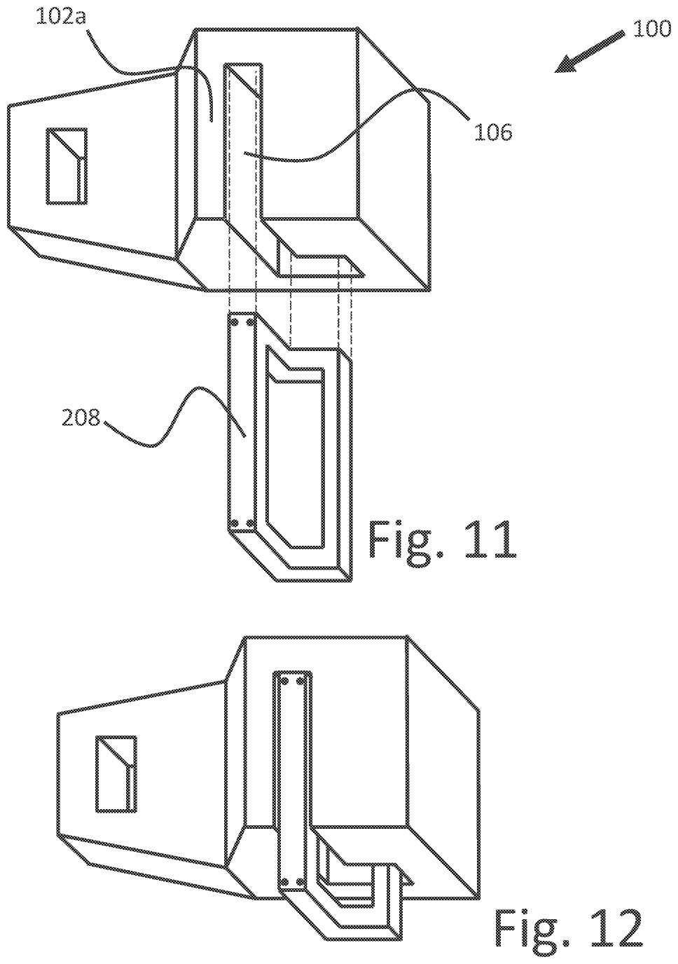

FIGS. 11 and 12 are a perspective view of the device of FIG. 3, in which the channel is shorter than the door handle, according to some embodiments of the present invention.

FIGS. 11 and 12 are three-quarters views showing the rear surface 102a of the base unit. In the example of FIGS. 11 and 12, the channel 106 and the door handle 208 have L-shaped bottom cross-sections. A portion of the door handle 208 is enclosed in the channel 106, while another portion of the door handle 208 juts out from the bottom of the base unit.

FIGS. 11 and 12 are three-quarters views showing the rear surface 102a of the base unit. In the example of FIGS. 9 and 10, the channel 106 and the door handle 208 have L-shaped bottom cross-sections. The hand grip 212 and a portion of the stem 210 are enclosed in the channel 106, while another portion of the stem 210 juts out from the rear surface 102a of the base unit.

In some embodiments of the present invention, the channel 106 is both shorter and less deep than the door handle 208, and the door handle juts out both from the bottom (FIGS. 11-12) and from the rear (FIGS. 9-10) of the base unit.

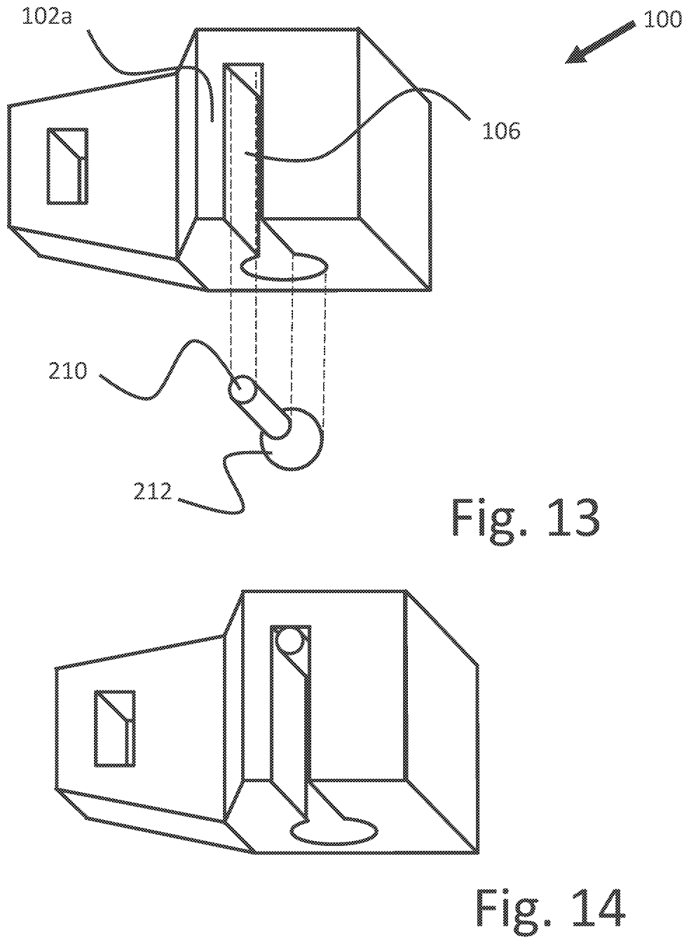

FIGS. 13 and 14 are a perspective view of the device of FIG. 3, in which the channel 106 matches the shape of door handle in which the stem 210 is a single shaft and the hand grip 212 is bulb-shaped, according to some embodiments of the present invention.

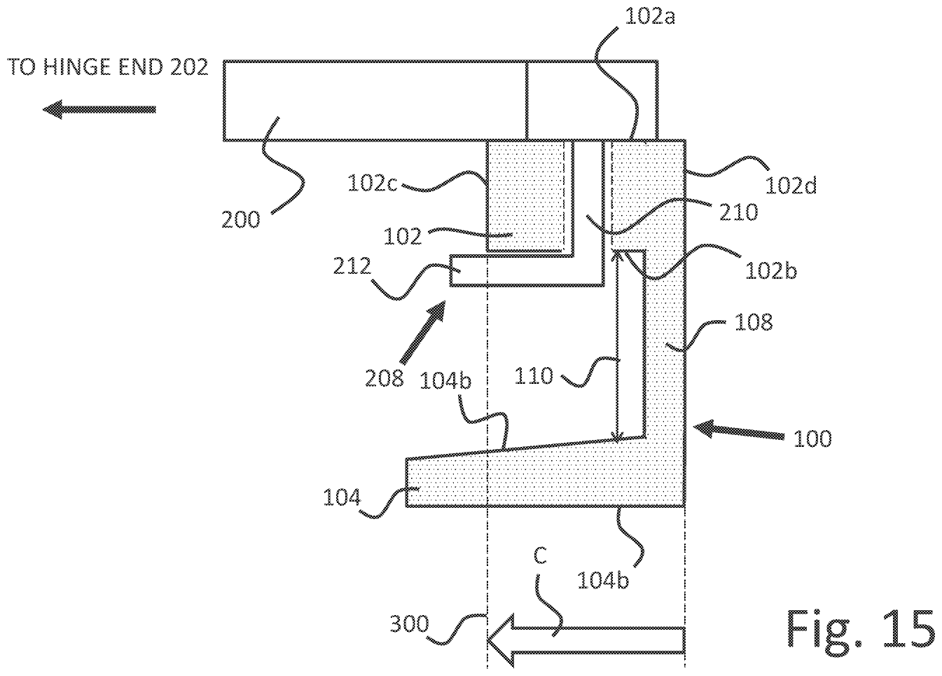

FIG. 15 is a top cross-sectional view of a device 100 for handling a door 200, in which a panel 104 is located ahead of the base unit 102 and in which the panel 104 extends toward a hinge end 202 of the door 200, according to some embodiments of the present invention.

The device 100 of FIG. 15 includes a base unit 102, a connection unit 108, and a panel 104. The base unit has a channel 106 configured to receive at least a portion of the stem 210 of a door handle 208, as described above. The base unit has a rear surface 102a and a front surface 102b, as described above.

The connection unit 108 extends forward from the front surface 102b of the base unit 102, and having a front section joined to the panel 104, such that a gap 110 is formed between the panel 104 and the front surface 102b of the base unit 102. In this manner, a user may place a shoulder or elbow in the gap 110 to manipulate the door.

In some embodiments of the present invention, the panel 104 has a rear surface 104a facing the base unit 102 and front surface 104b facing away from the base unit, and the rear surface 104a is joined to the connection unit 110 at an angle larger than 90 degrees and smaller than or equal to 180 degrees. As explained above, this increases the structural strength of the panel and enables more efficient transmission of force from the panel 104 to the door 200.

In the device 100, the base unit 102 has a first lateral side 102c and a second later side 120d opposite each other and connecting the front surface 102b to the rear surface 102a. The connection unit 108 extends forward from a portion of the front surface 102b at or near the second lateral side 102d. The first lateral side 102c is closer to the hinge end 202 than the second lateral side 102d is, such that the panel 104 extends from the connection unit 108 toward a projection 300 of the first lateral side 102c and toward the hinge end 202. The panel may extend beyond the projection of the first lateral side. In other words, the panel 104 extends laterally ahead of the front surface 102b from the connection unit 108 in a direction C that extends from the second lateral side 102d to the first lateral side 102c. In other words, when joined to a door handle, the panel 104 extends from the connection unit 108 toward from the hinge end 202 of the door 200. In some embodiments of the present invention, the panel 104 is substantially parallel to the front surface 102b of the base unit 102.

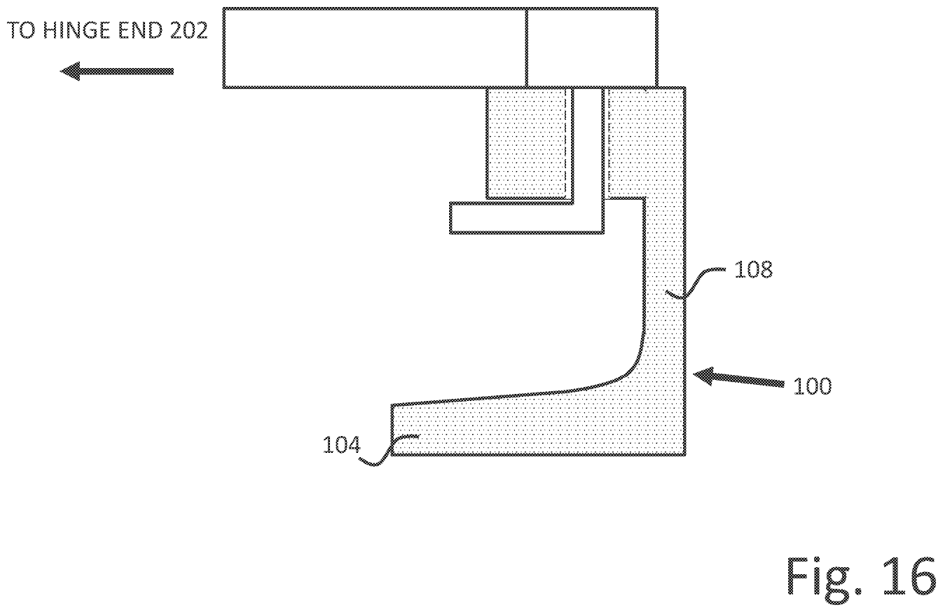

FIG. 16 is a top cross-sectional view of a device 100 for handling a door, in which a panel 104 is located ahead of the base unit 102 and in which the panel 104 extends toward a hinge end 202 of the door, where a connection unit 108 has a rounded surface, according to some embodiments of the present invention.

The device 100 of FIG. 16 has all the features of device 100 of FIG. 15, described above. The difference lies in the fact that in FIG. 15, the connection unit 108 has a curved surface, such that the reinforcement location at which the connection unit 108 and the panel 104 meet is about 180 degrees.

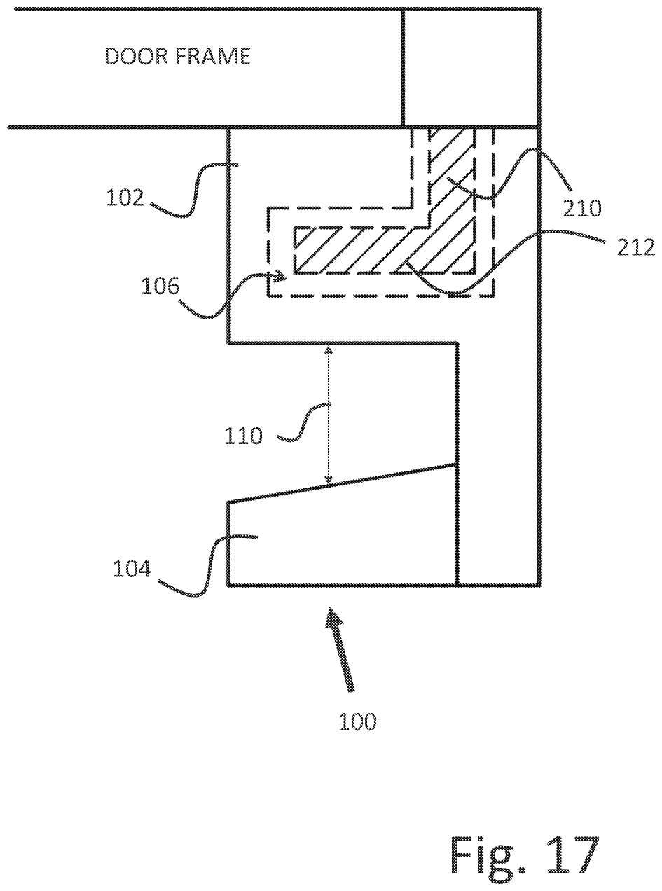

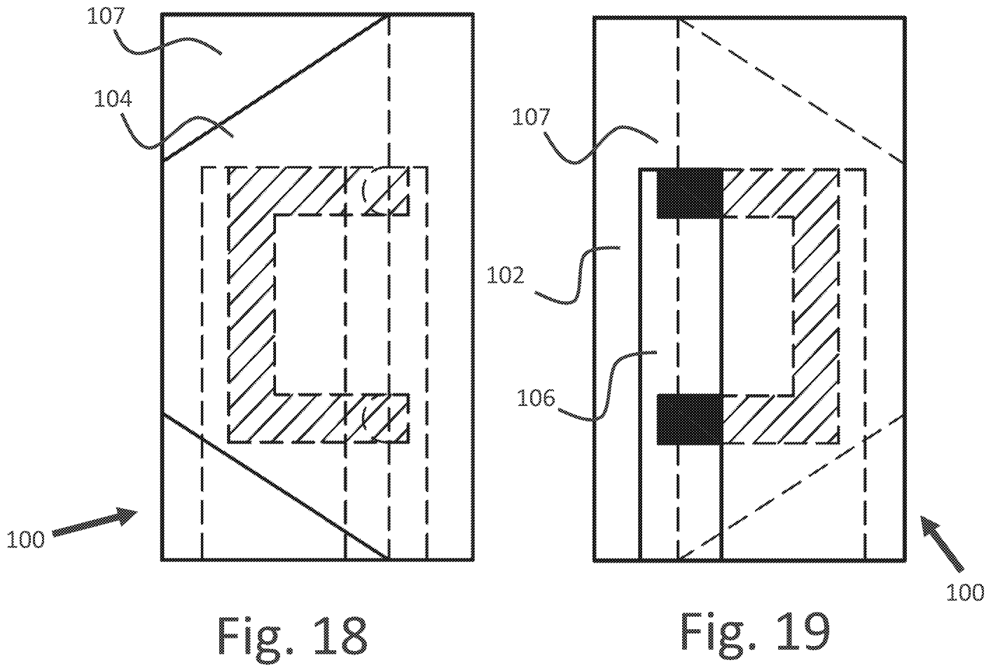

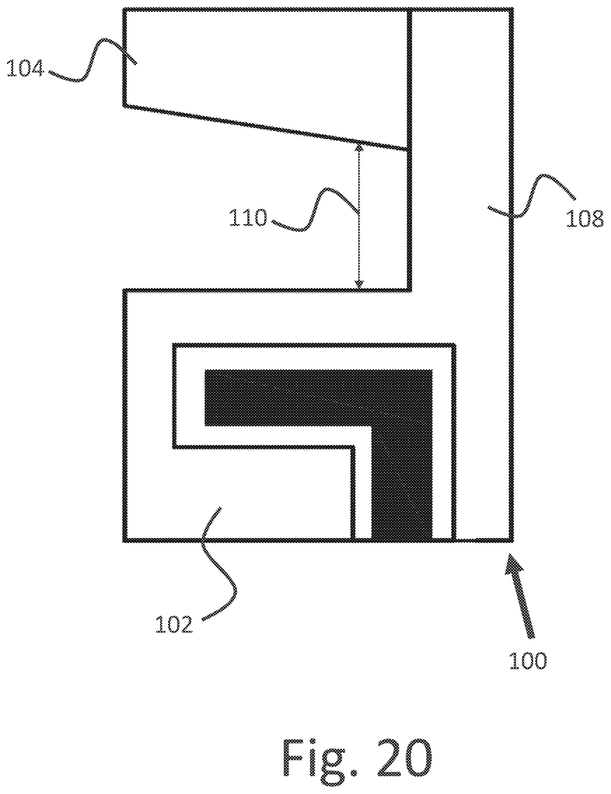

FIG. 17 is a top cross-sectional view of a device for handling a door, in which a base unit surrounds the door handle and a panel is located ahead of the base unit and extends toward a hinge end of the door, according to some embodiments of the present invention. FIG. 18 is a front view of the device of FIG. 17, according to some embodiments of the present invention. FIG. 19 is a rear view of the device of FIG. 17, according to some embodiments of the present invention. FIG. 20 is a bottom view of the device of FIG. 17, according to some embodiments of the present invention.

The device 100 of FIGS. 17-20 is similar to the device 100 of FIG. 15 and of FIG. 16. In addition to all the features described with reference to FIGS. 15 and 16, the base unit 102 of the device 100 of FIGS. 17-20 also surrounds the hand grip 212. Therefore, the channel 106 is shaped to receive at least one portion of the stem 210 of the door handle and also to receive the hand grip 212 of the door handle. As mentioned above, in some embodiments of the present invention, the channel 106 is configured for a snug connection with the door handle (stem 210 and hand grip 212) to prevent wobbling and to efficiently transfer force from the panel 104 to the door 200.

In the examples of FIGS. 17 to 20, the connection between the connection unit 108 and the panel 104 is angular, as described with reference to FIG. 15. However, in some embodiments of the present invention, the connection between the connection unit 108 and the panel 104 is curved, as described above, with reference to FIG. 16.

FIGS. 19 and 20 show that the top section 107 of the base unit 102 is closed, to stop the device 100 from slipping down the door handle and falling on the floor. Due to this stopping function of the top section 107 of the base unit, the door handle supports the weight of the device 100 when the device 100 is joined to the door handle.

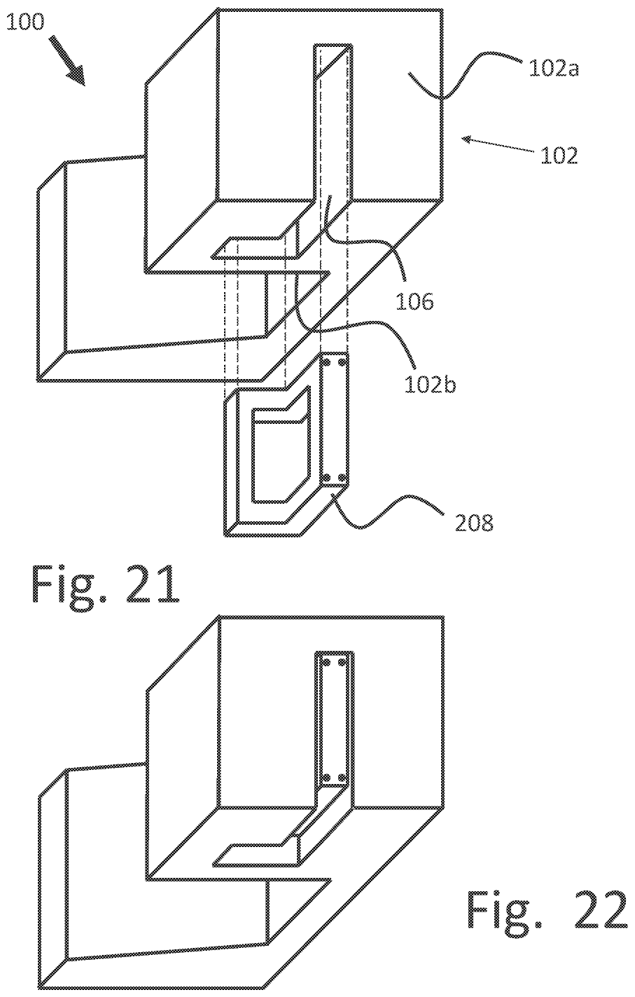

FIG. 21 is a perspective view of the device of FIG. 17 before connection to the door handle, according to some embodiments of the present invention. FIG. 22 is a perspective view of the device of FIG. 17 after connection to the door handle, according to some embodiments of the present invention.

FIGS. 21 and 22 are three-quarters views showing the rear surface 102a of the base unit. The channel 106 and the door handle 208 may L-shaped bottom cross-sections. In a variant the door handle has a bulb-shaped hand grip, and the channel 106 is shaped to receive at least part of the stem and the bulb-shaped hand grip, as described above with reference to FIGS. 13 and 14.

In a variant, the entirety of the door handle 208 is enclosed in the channel and the rear surface of the door handle 208 is flush with the rear surface 102a of the base unit. In another variant, the door handle 208 may jut out of the rear surface 102a of the base unit and/or out of the bottom of the base unit, as explained above with reference to FIGS. 9-12.

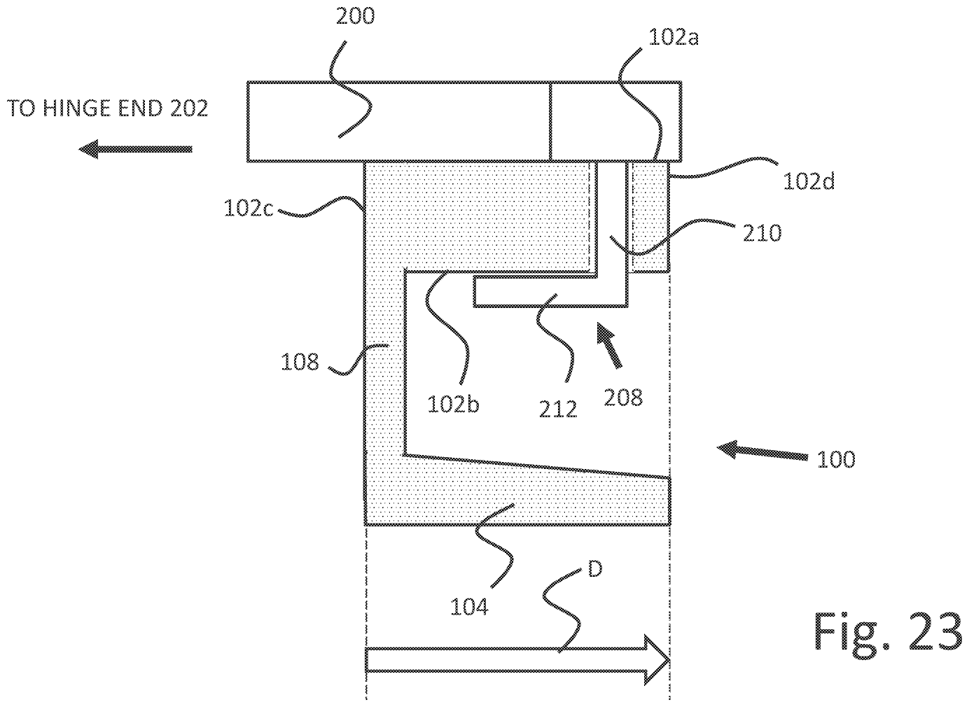

FIG. 23 is a top cross-sectional view of a device 100 for handling a door 200, in which a panel 104 is located ahead of the base unit 1-2 and in which the panel 104 extends away from a hinge end 202 of the door 200, according to some embodiments of the present invention.

The device 100 of FIG. 23 is similar to the device 100 of FIG. 15. The difference lies in the fact that in FIG. 23, the connection unit 108 extends forward from the front surface 102b, near the first lateral surface 102c, while the panel 104 extends laterally ahead of the front surface 102b from the connection unit 108 in a direction D that extends from the first lateral side 102c to the second lateral side 102d. In other words, when joined to a door handle, the panel 104 extends from the connection unit 108 away from the hinge end 202 of the door 200.

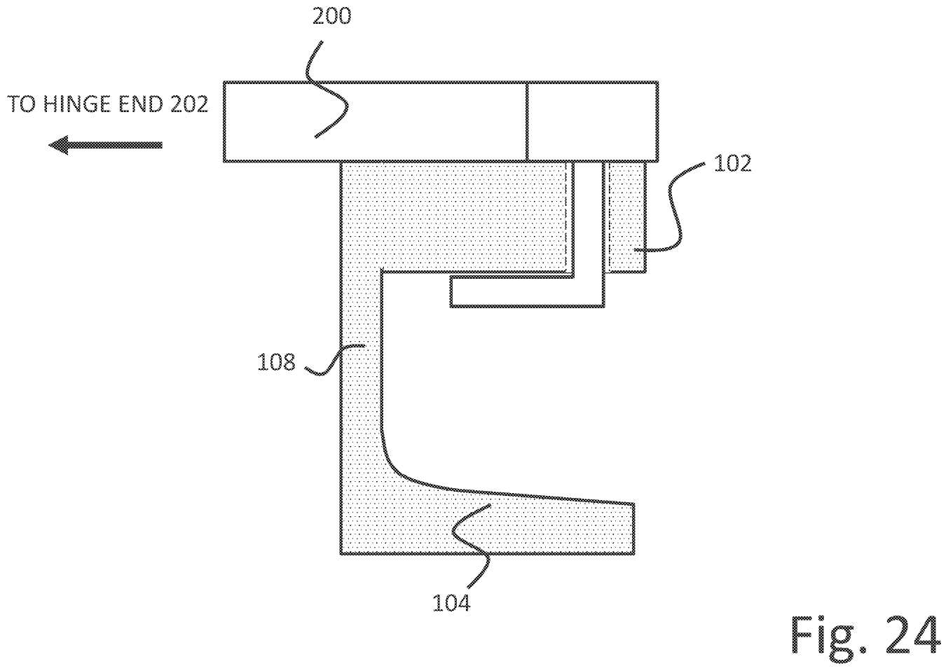

FIG. 24 is a top cross-sectional view of a device 100 for handling a door, in which the panel 104 is located ahead of the base unit 102 and in which the panel extends away from a hinge end 202 of the door, where a connection unit 108 has a rounded surface, according to some embodiments of the present invention.

The device 100 of FIG. 24 has all the features of device 100 of FIG. 23, described above. The difference lies in the fact that in FIG. 24, the connection unit 108 has a curved surface, such that the reinforcement location at which the connection unit 108 and the panel 104 meet is about 180 degrees.

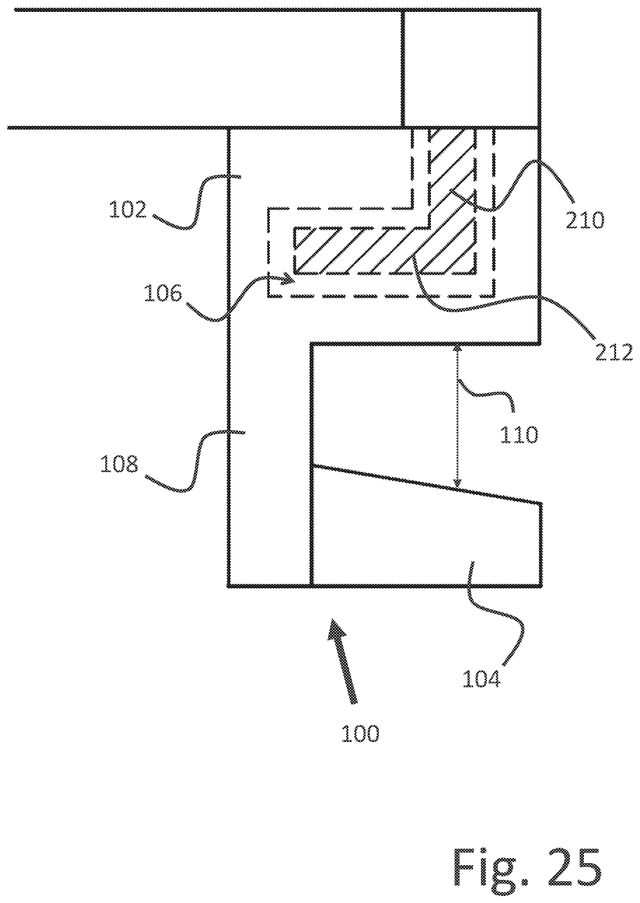

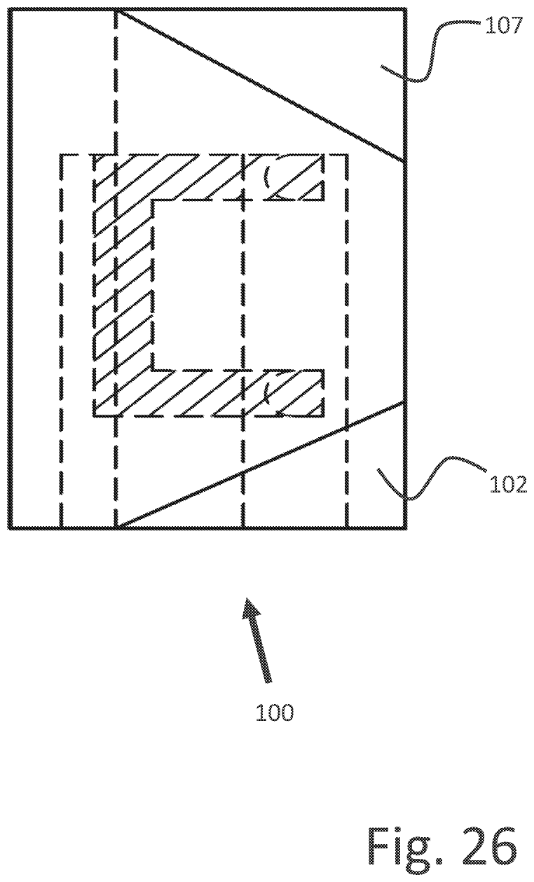

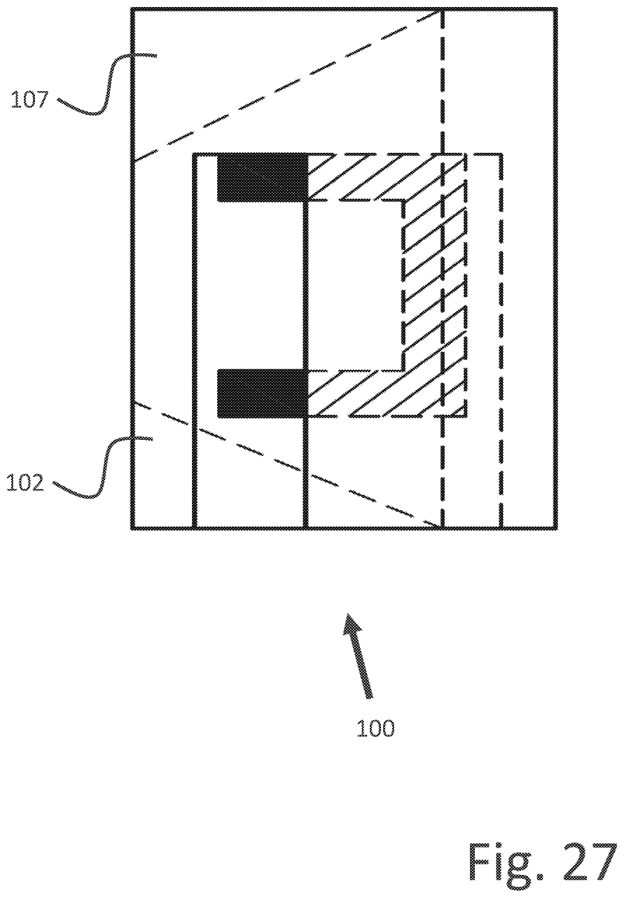

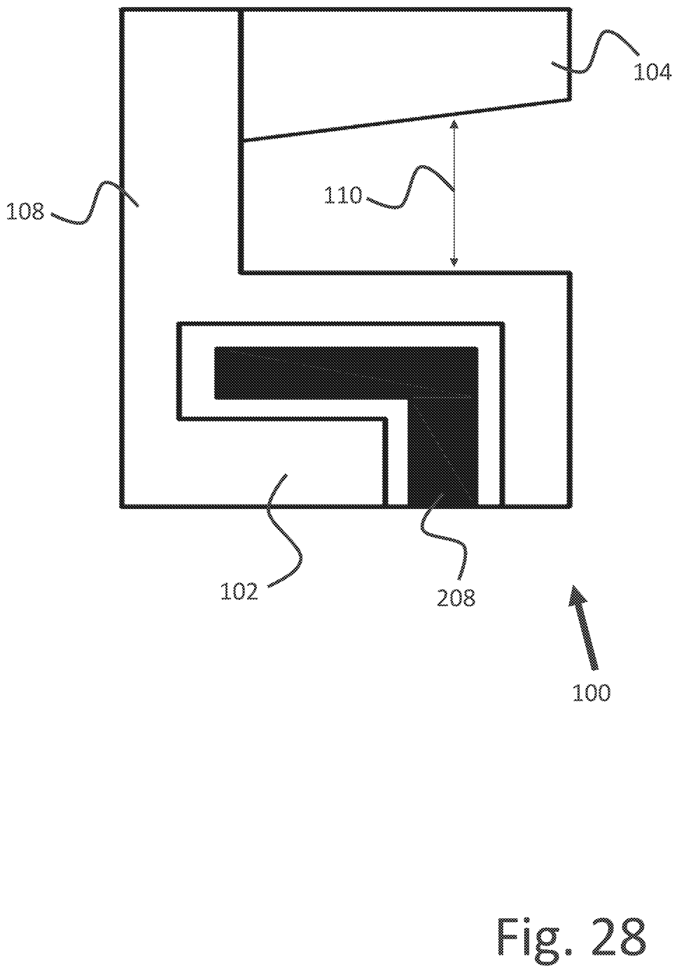

FIG. 25 is a top cross-sectional view of a device for handling a door, in which, in which a base unit surrounds the door handle and a panel is located ahead of the base unit and extends away from a hinge end of the door, according to some embodiments of the present invention. FIG. 26 is a front view of the device of FIG. 25, according to some embodiments of the present invention. FIG. 27 is a rear view of the device of FIG. 25, according to some embodiments of the present invention. FIG. 28 is a bottom view of the device of FIG. 25, according to some embodiments of the present invention.

The device 100 of FIGS. 25-28 is similar to the device 100 of FIG. 23 and of FIG. 24. In addition to all the features described with reference to FIGS. 23 and 24, the base unit 102 of the device 100 of FIGS. 25-28 also surrounds the hand grip 212. Therefore, the channel 106 is shaped to receive at least one portion of the stem 210 of the door handle and also to receive the hand grip 212 of the door handle. As mentioned above, in some embodiments of the present invention, the channel 106 is configured for a snug connection with the door handle (stem 210 and hand grip 212) to prevent wobbling and to efficiently transfer force from the panel 104 to the door 200.

In the examples of FIGS. 25 to 28, the connection between the connection unit 108 and the panel 104 is angular, as described with reference to FIG. 23. However, in some embodiments of the present invention, the connection between the connection unit 108 and the panel 104 is curved, as described above, with reference to FIG. 24.

FIGS. 26 and 27 show that the top section 107 of the base unit 102 is closed, to stop the device 100 from slipping down the door handle and falling on the floor. Due to this stopping function of the top section 107 of the base unit, the door handle supports the weight of the device 100 when the device 100 is joined to the door handle.

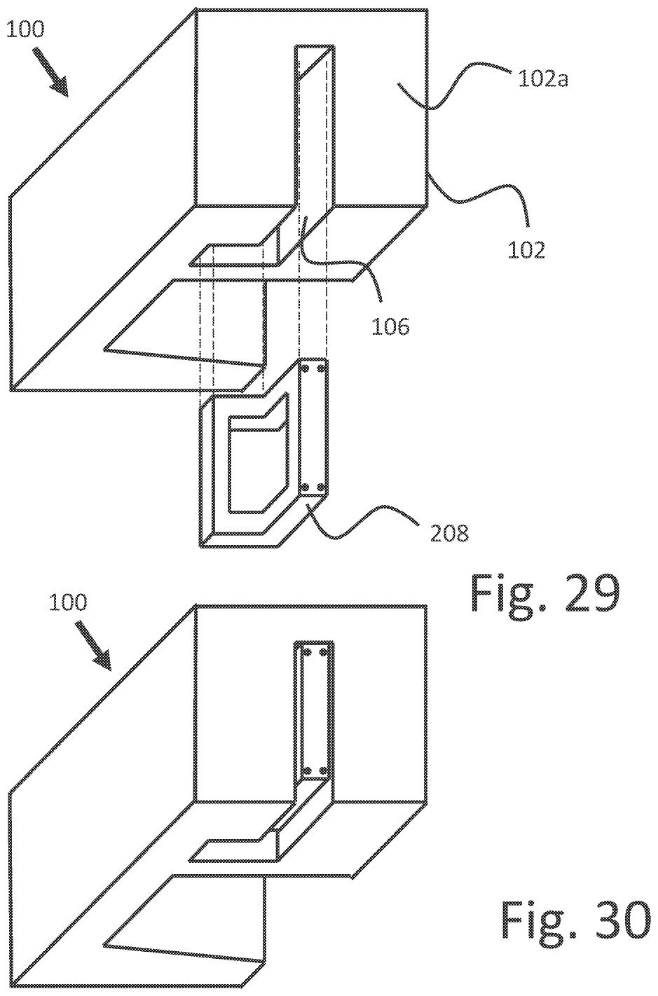

FIG. 29 is a perspective view of the device of FIG. 25 before connection to the door handle, according to some embodiments of the present invention. FIG. 30 is a perspective view of the device of FIG. 25 after connection to the door handle, according to some embodiments of the present invention; and

FIGS. 29 and 30 are three-quarters views showing the rear surface 102a of the base unit. The channel 106 and the door handle 208 may L-shaped bottom cross-sections. In a variant the door handle has a bulb-shaped hand grip, and the channel 106 is shaped to receive at least part of the stem and the bulb-shaped hand grip, as described above with reference to FIGS. 13 and 14.

In a variant, the entirety of the door handle 208 is enclosed in the channel and the rear surface of the door handle 208 is flush with the rear surface 102a of the base unit. In another variant, the door handle 208 may jut out of the rear surface 102a of the base unit and/or out of the bottom of the base unit, as explained above with reference to FIGS. 9-12.

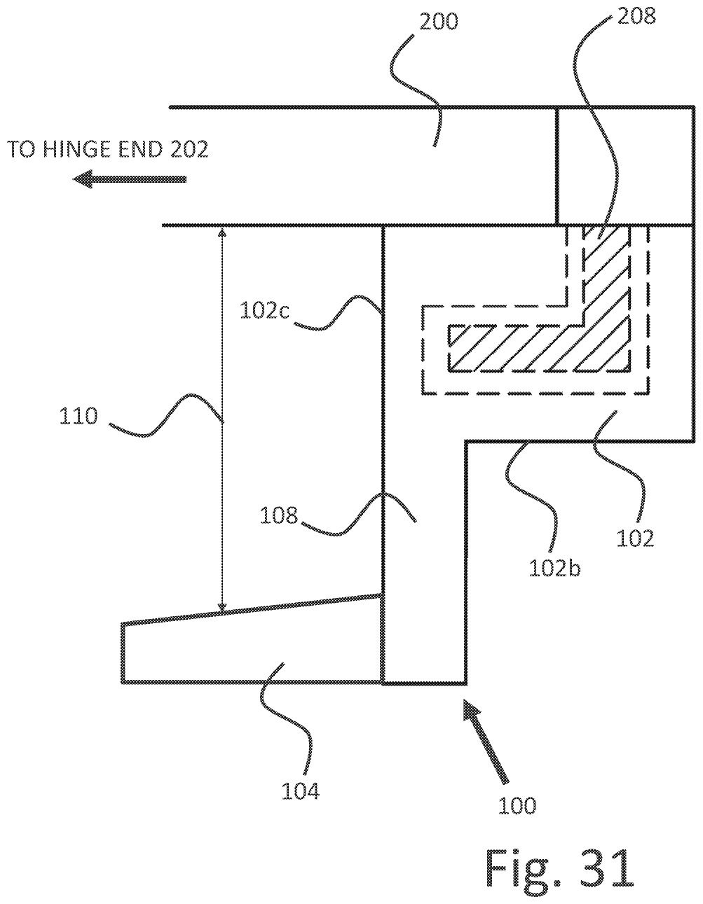

FIG. 31 is a top cross-sectional view of a device for handling a door 100, in which a connection unit 108 extends forward from a front surface 102a of a base unit 102 which is near the lateral surface 102c facing the hinge end 202 of the door 200, and a panel 104 extends from the connection unit 108 toward a hinge end 202 of the door 200 to form a gap 110 between the door 200 and the panel 204, according to some embodiments of the present invention.

The device 100 of FIG. 31 is similar to the device 100 of FIG. 25. The connection unit 108 extend forward from the front surface 102b of the base unit 102 near the first lateral surface 102c facing the hinge end 202 of the door 200. The difference lies in the fact that in FIG. 31, the panel 104 extends from the connection 108 toward the hinge end 202 of the door. Therefore, when the device 100 is joined to the door handle 208, the gap 110 is created between the panel 104 and the door 200.

The connection between the connection unit 108 and the panel 104 may be curved or angular, as explained above.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

What is claimed is:

1. A device for handling a door, the door having a door handle which comprises a stem and a hand grip, the device comprising:
a base unit having a channel opening at a bottom section of the base unit, the channel being closed by a top section of the base unit, the channel being configured to receive at least one portion of the stem of the door handle so as to slip the base unit onto the door handle to connect the base unit to the door handle;
an extension unit extending outwardly from the base unit and comprising a panel substantially parallel to the door, such that a force applied on the panel is transferred to the base unit, via the base unit to the door handle, and via the door handle to the door.

2. The device of claim 1, wherein the base unit is further configured to surround the hand grip, and the channel is shaped to further receive the hand grip.

3. The device of claim 1, wherein the base unit is configured to hold the stem between the door to the hand grip.

4. The device of claim 1, wherein the channel is configured for a snug connection with the at least one portion of the stem.

5. The device of claim 1, wherein the panel of the extension unit extends beyond a width of the door.

6. The device of claim 5, wherein:
the base unit has a rear surface facing the door when the base unit is connected to the door handle, a front surface facing away from the door when the base unit is connected to the door handle, and lateral surfaces extending on lateral sides of the base unit between the rear surface and the front surface;
the device comprises a connection unit connecting the panel to one of the lateral surfaces of the base unit.

7. The device of claim 6, herein the connection unit tapers from the front surface to the rear surface.

8. The device of claim 1, wherein:
the base unit has a rear surface facing the door and front surface facing away from the door, when the base unit is connected to the door handle;
the extension unit comprises a connection unit extending forward from the front surface, the connection unit having a front section joined to the panel, such that a gap is formed between the panel and the front surface of the base unit.

9. The device of claim 8, wherein:
the panel has a rear surface facing the base unit and front surface facing away from the base unit;
the rear surface of the panel is joined to the connection unit at an angle larger than 90 degrees and smaller than or equal to 180 degrees.

10. The device of claim 8, wherein:
the base unit has a first lateral side and a second later side opposite each other and connecting the front surface to the rear surface;
the connection unit extends forward from a portion of the front surface at or near the first lateral side;
the panel extends laterally, ahead of the front surface, from the connection unit in a direction that extends from the first lateral side to the second lateral side.

11. The device of claim 8, wherein:
the base unit has a first lateral side and a second later side opposite each other and connecting the front surface to the rear surface;
the connection unit extends forward from a portion of the front surface at or near the first lateral side;
the panel extends laterally, ahead of the front surface, from the connection unit in a direction that extends from the second lateral side to the first lateral side.

12. The device of claim 1, wherein:
the base unit has a rear surface facing the door and front surface facing away from the door, when the base unit is connected to the door handle;
the extension unit comprises a connection unit extending forward from the front surface, the connection unit having a front section joined to the panel;
the base unit has a first lateral side facing a hinge end of the door and a second later side opposite the first lateral side, the first lateral side and the second lateral side connecting the front surface to the rear surface;
the connection unit extends forward from a portion of the front surface at or near the second lateral side;
the panel extends toward a hinge end of the door.
